(19) United States
(12) Patent Application Publication
(10) Pub. No.: US 2010/0164822 A1
(43) Pub. Date: Jul. 1, 2010

(54) COIL FOR ANTENNA

(75) Inventors: Noriaki Iwasaki, Tokyo (JP); Hozumi Ueda, Tokyo (JP)

Correspondence Address: CANTOR COLBURN, LLP, 20 Church Street, 22nd Floor, Hartford, CT, 06103, US

(73) Assignee: SUMIDA CORPORATION, Tokyo (JP)

(21) Appl. No.: 12/278,904

(22) PCT Filed: Nov. 9, 2006
(86) PCT No.: PCT/JP2006/322394

§ 371 Date: Aug. 8, 2008

(30) Foreign Application Priority Data
Feb. 8, 2006 (JP) 2006-030623

(51) Int. Cl. H01Q 7/08

(52) U.S. Cl. 343/788

(57) ABSTRACT

The present invention is to provide a coil for an antenna with small inductance fluctuation and high productivity. According to the invention, an antenna coil 1 includes: a bar-shaped core 10, a bobbin 20 which is structured as to at least cover the most deflectable face of the bar-shaped core 10, a coil 30 which is wound around the surface of the bobbin 20, and a resin molded body 3 which covers the bobbin 20 around which the coil 30 is wound.

### TECHNICAL FIELD OF THE INVENTION

The present invention relates to a coil for an antenna utilized in a smart key system.

### TECHNICAL BACKGROUND

In recent years, there has been implementation of a smart key system that allows locking/unlocking of houses or car doors without actually inserting a key itself, but by moving a key close to the smart key system. The smart key system is a system that allows the locking/unlocking of a door by signals transmitted and received between a key and a reader embedded in a door or a side mirror. Particularly, even without preinstalled battery in a key, by generating an AC magnetic field from a reader that is connected to a power supply, a voltage will be induced in a coil inside the key and an electric current will occur once the key approaches the AC magnetic field. Therefore, the system where carrying around a key is simple and handy, and battery replacement is not required, can be constructed.

When the above smart key system's practical usage is put into consideration, there is a need to transmit signals from a key to a reader when the key enters the distance of less than 2 or 3 meters from the reader. Therefore, the material being used for the core of a coil for an antenna used for the reader is usually high permeability magnetic material (ex. Ferrite). This type of core manufactured from magnetic material generally lacks toughness. Hence, the repeated locking and unlocking of the door may cause cracks and breaks in the material. As a result, there is an issue in which the signal transmission strength between a key and a reader degrades.

To resolve this issue, there is a potting type bar antenna having a core such as a ferrite, a bobbin that envelops the core and holds the coil which is wound around the core in an insulated manner, a case that stores the core and the bobbin, and a potting material which fills the gap between the core and the bobbin and that between case and the bobbin (ex. Refer patent document 1). On the other hand, there is a molding type bar antenna composed of molded resin which contains a ferrite(or other material) core and a coil wound around and insulated with the core. Conclusively, the possibility of damaging the core can be significantly reduced by wrapping the surroundings of a core with a resin.
[Patent Document 1] Japanese Patent Application Laid-Open No. 2001-358522 (Paragraph number 0013, FIG. 1 and FIG. 2)

### DISCLOSURE OF THE INVENTION

### Problem to be Solved

However, the aforementioned conventional bar antenna suffers from the following problems. The potting type bar antenna requires significant amount of time to dry a resin and therefore lacks high productivity. On the other hand, with regard to the molding type bar antenna, production time is short because there is no drying process in production. However, the heat during the molding process creates a thermal stress on the core and the inductance value may change. The problems about the stress on the core and the change of the inductance value is caused by expansion or shrinkage of the potting material and molded resin according to environmental temperature. Especially, when the stress is created perpendicular to the length of the core, depending on the surface of the core, it may suffer deflection. Thus, the actual inductance value will significantly fluctuate from the initially designated value.

In view of the above issues, the present invention is to provide a coil for an antenna that excels in production with minimal inductance value fluctuation.

### Means to Solve the Issues

In order to solve the above issues, according to an aspect of the invention, a coil for an antenna includes: a bar-shaped core, a bobbin whose length is longer than longer dimension of the bar-shaped core and which is structured to envelop the surface where the bar-shaped core is most susceptible to deflection, a coil that is wound around the surface of the bobbin, and a resin molded body that envelops the bobbin wrapped by the coil.

The aspect of the present invention incorporates the structure in which the bar-shaped core is configured to cover the surface, that is most susceptible to deflection, with the bobbin, and the bobbin is wrapped with a resin material. Therefore, even though either the molding or the environment temperature change results in addition of a heat stress, because the pressure is received by the bobbin and not by the bar-shaped core, the bar-shaped core is less likely to transform its shape, and the inductance value does not fluctuate. Also, similarly to the potting type, since the bobbin is wrapped with resin, the drying time is not required much at all, and the resulting coil for antenna increases the production rate.

Furthermore, in another aspect of the invention, the bobbin may be structured so that the bobbin can slide along the length direction of the bar-shaped core, and the bobbin may have a first opening portion that connects to one end face of the bobbin in the length direction of the bar-shaped core and a second opening portion that pushes other end face opposing to the one end face.

In this way, by allowing the bar-shaped core to slide along its longer axis inside the bobbin, the inductance value can be adjusted by staggering the bar-shaped core relative to the coil before enveloping the surface of the bobbin using the resin molded body.

Also, in another aspect of the invention, a plurality of steps may be formed on the exterior circumference of the bobbin and the coil may be divided into a plurality of winding sections formed by the plurality of steps.

Also, in another aspect of the invention, the resin molded body may be a thermosetting resin.

The bar-shaped core of the invention, the composing part of the coil for the antenna, can be shaped as multi-sided prisms, cylinders, or cuboids, as long as one of the dimensions is longer than the others. Also the surface that is most susceptible to deflection on the bar-shaped core refers to the surface that is easily deflected when the bar-shaped core receives a thermal stress. The material for the bar-shaped core may be a ferrite type ceramics material or an amorphous metal type material. The desirable material for the bobbin is insulating material, especially those made from resin. In case of constructing the bobbin from resin, the three types of resins; thermoplastic, thermosetting, or UV setting may be used. However, it is more desirable to use thermosetting or UV setting type that do not deform from the heat of the coil.

### Advantage of the Invention

The invention is able to offer a coil for an antenna that excels in production rate with less fluctuation in inductance value.

### BRIEF DESCRIPTION OF DRAWINGS

FIG. 1 is a cross sectional view showing a coil for an antenna cut in parallel to the length of the coil regarding an embodiment of the invention.

FIG. 2 is a plane view of a main antenna part placed within the coil for the antenna referred in FIG. 1.

FIG. 3 is a cross sectional view of the main antenna part when cut along the line A-A referred in FIG. 2.

FIG. 4 is a simplified schematic view showing a bar-shaped core and a bobbin in the coil of the antenna regarding the embodiment of the invention.

FIG. 5 is a simplified schematic diagram showing the state of the bar-shaped core in which it is enveloped by the bobbin which includes the openings in the directions C and D as shown in FIG. 4.

### NUMERAL REFERENCES

1: Coil for the antenna,

2: Main antenna part,

3: Resin molded body,

10: Bar-shaped core,

20: Bobbin,

26: Second opening portion,

27: First opening portion,

30: Coil,

### DESCRIPTION OF PREFERRED EMBODIMENTS

A coil for an antenna regarding an embodiment of the invention will be explained referring to the figures, as below.

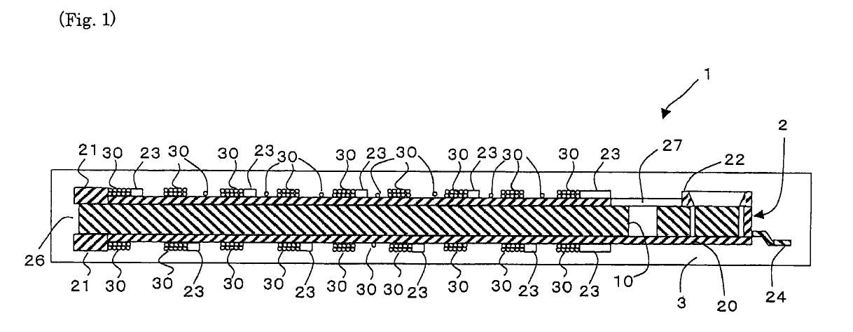

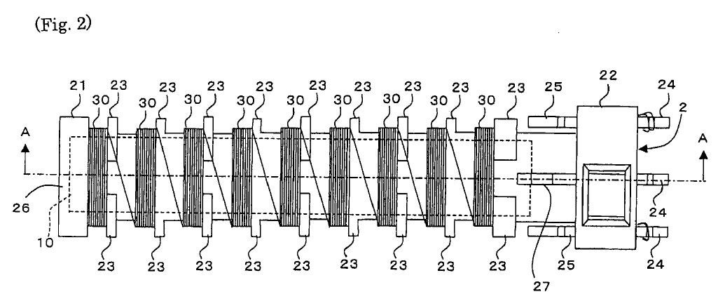

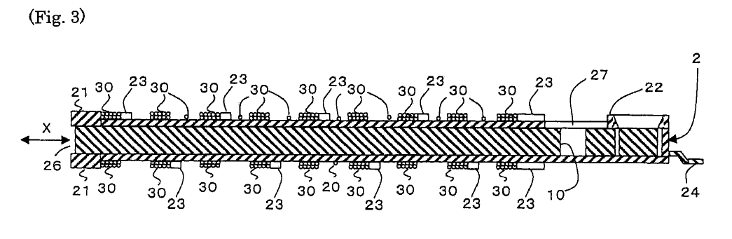

FIG. 1 is a cross sectional view showing a coil for an antenna cut in parallel to the length of the coil regarding an embodiment of the invention. FIG. 2 is a plane view of a main antenna part placed within the coil for the antenna referred in FIG. 1. FIG. 3 is a cross sectional view of the main antenna part when cut along the line A-A referred in FIG. 2.

As shown on FIG. 1, a coil 1 for an antenna contains a resin molded body 3, which covers the outside of a main part 2 of the antenna. The resin molded body 3 is structured so that the main part 2 of the antenna is located within the mold (not shown in the figure), and the resin is supplied in the mold to seal the main part 2 of the antenna. Preferably, the resin molded body 3 is manufactured with twin fluid mixture of thermosetting resin or UV setting resin. However, the resin molded body 3 may be manufactured with resin type not listed above.

The main part 2 of the antenna, as shown on FIG. 1 and FIG. 2, includes a bar-shaped core 10 which is longer in one direction, and a bobbin 20 which is at least as long as the bar-shaped core 10 along the longer dimension, and which at least covers the surface of the bar-shaped core 10 that is most susceptible to deflection, and a coil 30 that winds around the surface of the bobbin 20 and so on.

The bar-shaped core 10 in the embodiment is a core of ferrite type that has a board-like rectangular shape, which is elongated in one direction. As a ferrite type core, it is possible to use Mn—Zn type ferrite and Ni—Zn type ferrite. Other ferrite type core or a different type of core besides that made of ferrite may be used.

The bobbin 20 has an elongated cylindrical shape that covers the bar-shaped core 10 from the outside. The bobbin 20 is a one-piece molded body which is made of resin and comprises a ring 21 and a ring 22 on its both ends which are slightly wider than the body of the bobbin 20, and a step 23 which project in series keeping the same distances apart around the region of the bobbin 20 closer to the ring 21 and between the ring 21 and the ring 22. However, it is possible to prepare at least one of the ring 21, the ring 22 or the step 23 separately from the main body of the bobbin 20 and attach them to the bobbin 20 using an adhesive.

The step 23 which is closest to the ring 21 projects towards the front, up and down sides of the page containing FIG. 2, but does not project towards the back side of the page containing FIG. 2. Similarly, the step 23 which is the second step counting from the ring 21 projects towards the back, up and down sides of the page containing FIG. 2, but does not project towards the front side of the page containing FIG. 2. In this way, the step 23 which projects over the front side of the page of FIG. 2 and the step 23 which does not are arranged from the ring 21 towards the ring 22 in an alternating manner.

Onto the ring 22 are fixed three electrode terminals 24, 24, 24 which project in outer direction of the bobbin 20 along its longer dimension, and two electrode terminals 25, 25 which project towards the ring 21 along the longer dimension of the bobbin 20. Of the three electrode terminals 24, 24, 24, two of the electrode terminals at both ends are connected to each ends of the coil 30. Also, of the three electrode terminals 24, 24, 24, the electrode terminal 24 in the center and the terminal 24 at one end are each connected to a lead wire (not shown) stretching from a battery. The electrode terminal 24 not connected to the lead wire touches the center electrode terminal 24 inside the bobbin 20. For this reason, the lead wire and each of the terminals of the coil 30 are electronically connected.

In the bobbin 20, between the ring 22 and the step 23 closest to the ring 22 is located a first opening portion 27 which connects to the bar-shaped core 10. Also, in the bobbin 20, the ring 21 possesses a second opening portion 26 on its face that connects to the end of the bar-shaped core 10. Because of these opening portions, either by pushing the bar-shaped core 10 from the first opening portion 27 towards the ring 21 or from the second opening portion 26 towards the ring 22, the bar-shaped core 10 can be moved inside the bobbin 20 in both directions along its longer dimension, as shown by the double arrow X in FIG. 3.

In the embodiment, the length of the longer dimension of the bar-shaped core 10 is set to 55 mm, and the empty region inside the bobbin 20 into which the bar-shaped core 10 is inserted has the length of its longer dimension set to 58 mm. By inserting a thin jig into the first opening portion 27 or the second opening portion 26 and pushing the bar-shaped core 10, the bar-shaped core 10 can be stored in the empty region of the bobbin 20 in which the bar-shaped core 10 is inserted. Alternatively, the end of the bar-shaped core 10 can be projected out of the second opening portion 26.

A single of the coil 30 is wound around the outer face of the bobbin 20 in such a way so that it is subdivided into multiple sections. More explicitly, the coil 30 is connected to the electrode terminal 24, and wound around the region (winding region) between the ring 21 and the step 23 closest to the ring 21. next, the coil 30 is wound around the region (winding region) between the step 23 closest to the ring 21 and the step 23 secondary counted from the ring 21, is wound around each of the regions (winding region) between the steps 23 in order, and finally connected to the separate electrode terminal 24. Alternatively, the coil 30 can be wound around the surface of the bobbin 20 continuously without sectioning. In this case, the steps 23 are not necessary.

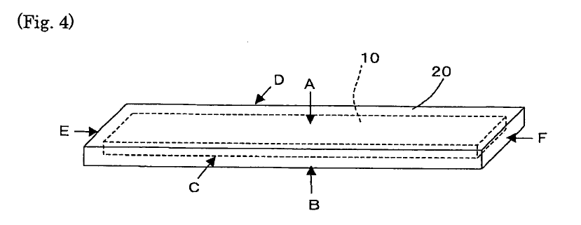

FIG. 4 is a schematic view showing the bar-shaped core 10 and the bobbin 20 in a simplified form.

When the bar-shaped core 10 is covered with the resin molded body 3, a thermal stress is added to the bar-shaped core 10 because of the heat during molding. The face of the bar-shaped core 10 that is most susceptible to deflection when the thermal stress is applied onto the bar-shaped core 10 is the face of the bar-shaped core 10 with the largest area. Because of this, it is necessary to protect the largest face of the bar-like 10 from a deflection due to the thermal stress. In other words, the bobbin 20 must be designed so that the faces in direction A and direction B in FIG. 4 must be protected from deflection. The next readily deflectable surface following the faces in direction A and direction B are the faces in direction C and direction D in FIG. 4. The least deflectable faces are the faces in direction E and direction F in FIG. 4.

In the embodiment, the bobbin 20, which is opened towards direction E in FIG. 4 and is practically closed in other five directions, is used. Even though the first opening portion 27 is formed on the face in direction A, because the opening portion 27 is so small, the bar-shaped core 10 does not deflect even when the resin molded body 3 contacts with the bar-shaped core 10. A different form of bobbin than the one shown in this embodiment may be used. For example, a bobbin which is closed in all A˜F directions in FIG. 4, or a bobbin which is opened in only E and F directions may be used.

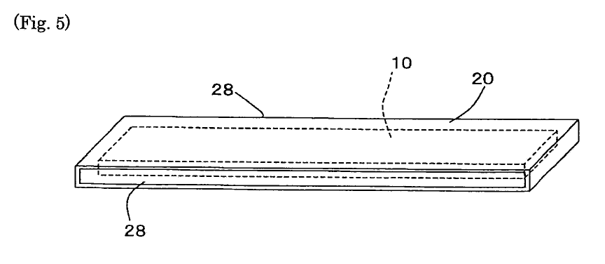

FIG. 5 is a schematic view showing a simplified setting in which the bar-shaped core 10 in FIG. 4 is covered by the bobbin 20 which possesses openings in direction C and D shown in FIG. 4.

As shown in FIG. 5, the bobbin 20 having the following structure may be applied. The largest face of the bar-shaped core 10 (the faces in the directions A and B in FIG. 4) and the face of the longer dimension of the bar-shaped core 10 (the faces in the directions E and F in FIG. 4) are closed and opening portions 28, 28 are formed on the faces in the directions C and D in FIG. 4. It is also possible to use the bobbin 20 which possesses the opening portion 28 only on either of the faces in the directions C or D in FIG. 4. Also, it is possible to use the bobbin which is closed in directions A and B and open on all the other sides.

### Examples

Next, examples using the coils for antenna according to the present invention are explained.

As a bar-shaped core, a Mn—Zn type ferrite core with rectangular dimensions of width 7 mm×thickness 2 mm×55 mm is used. Also, two types of cylindrical bobbins which are open to both ends of its longer dimension that cover the bar-shaped core 10 are used. One bobbin has the length of 58 mm while the other has the length of 27 mm.

The bar-shaped core is inserted into the bobbin with length 58 mm so that the end of the longer-axis of the bar-shaped core does not protrude out of the bobbin, the opening portion of the bobbin is closed using an adhesive, and the coil is wound around the surface of the bobbin. Such a sample is called the “sample A”. Alternatively, the bar-shaped core is inserted into the bobbin with length 58 mm so that the end of the longer-axis of the bar-shaped core does not protrude out of the bobbin, the both ends of the bobbin are left open, and the coil is wound around the surface of the bobbin. Such a sample is called the “sample B”. Finally, the bar-shaped core is inserted into the bobbin with length 27 mm so that the end of the longer-axis of the bar-shaped core protrudes out of the bobbin and the coil is wound around the surface of the bobbin. Such a sample is called the “sample C”.

In order to set up a close approximation to the setting in which the aforementioned samples are completely sealed with a resin, the aforementioned sample are put under the temperature range from −40 to 120 degrees C. and the inductance under such temperatures is measured. Also, based on the inductance measurement, the rate of change of the inductance, relative to the 20 degrees C. inductance measurement, for each sample and for each temperature is calculated. The inductance measurement as well as the rate of change in the inductance measurement for each of the samples in the temperature range from −40 to 120 degrees C. is shown respectively in Table 1 and Table 2.

TABLE 1

| Temperature ° C. | Sample A | Sample B | Sample C |
|---|---|---|---|
| 120 | 57.53 | 56.64 | 53.25 |
| 100 | 57.37 | 56.5 | 53.11 |
| 80 | 57.13 | 56.3 | 52.87 |
| 60 | 56.81 | 55.97 | 52.55 |
| 40 | 56.39 | 55.53 | 52.1 |
| 20 | 55.7 | 54.85 | 51.37 |
| 0 | 54.58 | 53.74 | 50.36 |
| −20 | 52.99 | 51.91 | 48.73 |
| −40 | 51.32 | 49.86 | 46.86 |

(Unit: μH)

TABLE 2

| Temperature ° C. | Sample A | Sample B | Sample C |
|---|---|---|---|
| 120 | 3.29% | 3.26% | 3.66% |
| 100 | 3.00% | 3.01% | 3.39% |
| 80 | 2.57% | 2.64% | 2.92% |
| 60 | 1.99% | 2.04% | 2.30% |
| 40 | 1.24% | 1.24% | 1.42% |
| 20 | 0.00% | 0.00% | 0.00% |
| 0 | −2.01% | −2.02% | −1.97% |
| −20 | −4.87% | −5.36% | −5.14% |
| −40 | −7.86% | −9.10% | −8.78% |

As shown in the Table 1, as for the inductance, the inductance increases in the order from the sample A, the sample B, the sample C respectively. Also, as shown in the table 2, the sample A had smaller rate of change of the inductance compared to the sample B. The sample B had a smaller rate of change of the inductance compared to that of the sample C. From this result, by sealing the bar-shaped core completely inside the bobbin, the bar-shaped core is protected from deformation due to the temperature change, and as the result change of the inductance seems to have decreased. On the other hand, if both ends of the bobbin are opened, the effectiveness of the protection against the deformation of the bar-shaped core decreases, and as the result, the rate of change of the inductance seems to have increased slightly. Also, if part along the longer dimension of the bar-shaped core is exposed to the outside of the bobbin, the effectiveness of the protection against the deformation of the bar-shaped core decreases even further, and as the result the rate of the change of the inductance seems to have increased.

### INDUSTRIAL APPLICATION OF THE INVENTION

The coil for antenna used in the present invention can be used for a key entry system for the automobiles or residence.

1. A coil for antenna comprising:
a bar-shaped core;
a bobbin whose longer dimension is longer than that of the bar-shaped core, and which at least covers the most deflectable face of the bar-shaped core;
a coil that is wound around the surface of the bobbin; and
a resin molded body that covers the bobbin on which the coil is wound.

2. The coil for antenna according to claim 1, wherein the bobbin comprises:
a structure that allows for the bar-shaped core to slide along its longer dimension;
a first opening portion which opens towards one end of the longer dimension of the bar-shaped core; and
a second opening portion which is formed for pushing both the one end of the bar-shaped core and the other end opposing the one end of the bar-shaped core.

3. The coil for antenna according to claim 1, further comprising a plurality of steps formed on the outer circumference of the bobbin, wherein the coil is wound so as to be divided into a plurality of winding sections formed by the plurality of steps.

4. The coil for antenna according to claim 1, wherein the resin molded body is made of a thermosetting resin.

5. The coil for antenna according to claim 2, further comprising a plurality of steps formed on the outer circumference of the bobbin, wherein the coil is wound so as to be divided into a plurality of winding sections formed by the plurality of steps.

6. The coil for antenna according to claim 2, wherein the resin molded body is made of a thermosetting resin.

7. The coil for antenna according to claim 3, wherein the resin molded body is made of a thermosetting resin.
